(19) United States
(12) Patent Application Publication
(10) Pub. No.: US 2007/0177379 A1
(43) Pub. Date: Aug. 2, 2007

(54) Light module

(76) Inventors: Yu-Yan Fu, Tanzih Township (TW); Chih-Kang Tung, Houlong Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/345,251

(22) Filed: Feb. 1, 2006

(51) Int. Cl. F21S 4/00

(52) U.S. Cl. 362/217

(57) ABSTRACT

A light module includes a printed circuit board, a plurality of lamps and a connector. The printed circuit board has a conductive wire surface. Each lamp has a connecting portion electrically connected to the printed circuit board. The connector is installed between the printed circuit board and the lamp for electrically connecting the connecting portion and the printed circuit board.

### BACKGROUND

The invention relates to a light module, and more particularly, to a light module of a display.

FIG. 1 discloses a conventional light module 10 comprising a frame 11, a plurality of lamps 12 in the frame 11, a connector 14, and a copper sheet 13 electrically connected to the lamps 12. The lamps 12 are fixed on the copper sheet 13 via the connector 14. A feedback circuit (not shown) connects to the copper sheet 13 and controls the lamps 12. In a conventional light module 10, lamps 12 are connected to the same copper sheet 13, and connected to the feedback circuit. The lamps 12 are not divided into several groups but are controlled via the feedback circuit. Because the brightness of each lamp may be different, the feedback circuit connecting the lamps 12 is not able to control lamps 12 regionally, thus, an average level of brightness of the light module 12 cannot be maintained across all the lamps 12.

### SUMMARY

A light module comprises a printed circuit board, a plurality of lamps and a connector. The printed circuit board has a conductive wire surface. Each lamp comprises a connecting portion electrically connected to the printed circuit board. The connector is installed between the printed circuit board and the lamp for electrically connecting the connecting portion and the printed circuit board. An extension direction of the lamp is substantially parallel to the surface of the conductive wires.

### BRIEF DESCRIPTION OF THE DRAWINGS

The invention can be more fully understood by reading the subsequent detailed description in conjunction with the examples and references made to the accompanying drawings, wherein:

FIG. 1 is a schematic diagram of a conventional light module.

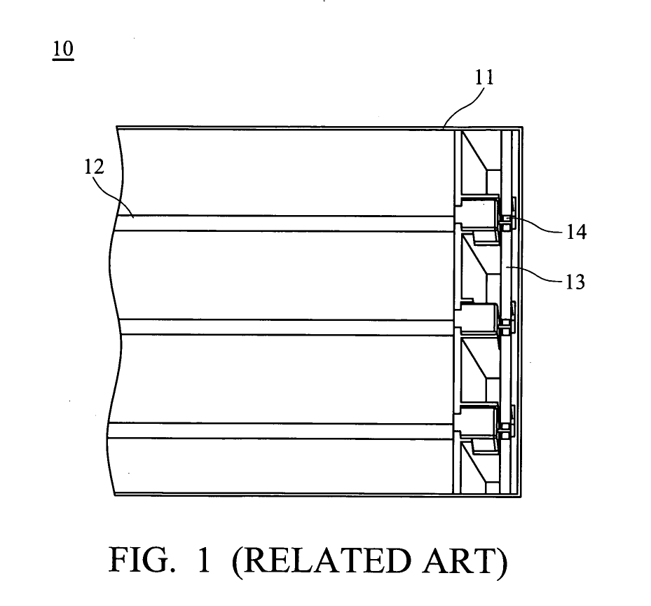

FIG. 2 is a schematic diagram of a light module of the present invention.

FIG. 3 shows an end of a lamp of the light module connected to a printed circuit board of FIG. 2.

### DETAILED DESCRIPTION

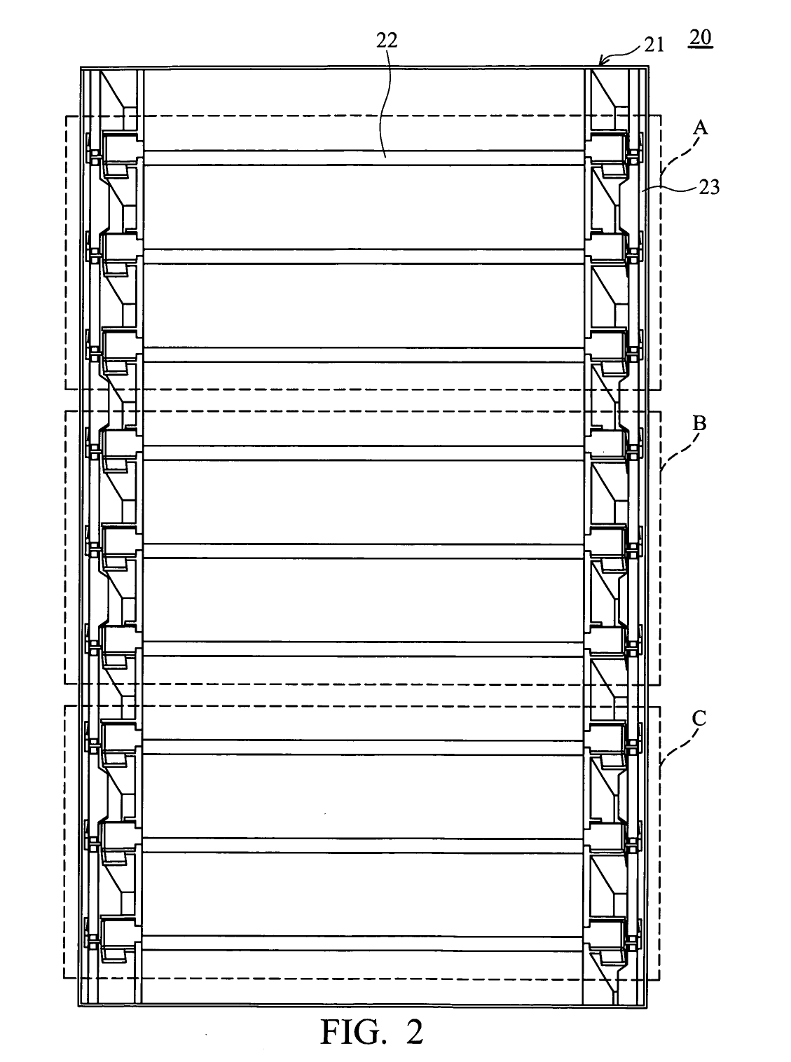

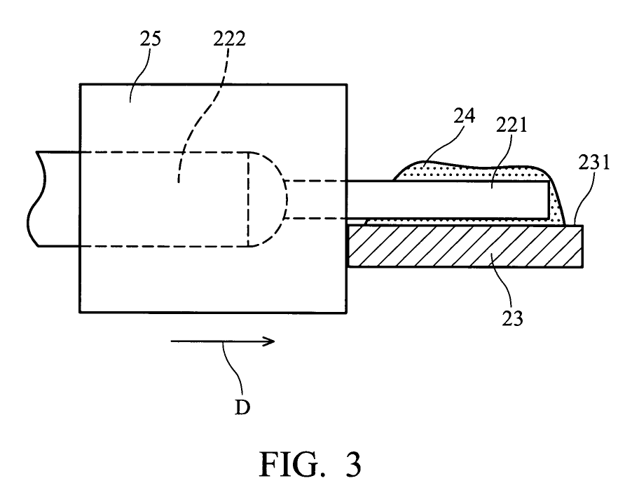

Referring to FIGS. 2 and 3, a light module 20 comprises a frame 21, a plurality of lamps 22, a printed circuit board 23, a connector 24, and an electrode cover 25. The printed circuit board 23 comprises a conductive wire surface 231 on which a feedback circuit (not shown) for controlling the lamps 22 regionally (shown by region A, region B and region C) is provided. Each lamp 22 comprises a connecting portion 221 and an electrode 222. The connecting portion 221 is electrically connected to the printed circuit board 23. The electrode 222 is electrically connected to the connecting portion 221. The electrode cover 25 covers the electrode 222 for protecting the electrode 222. An extension direction (shown by an arrow D) of the lamps 22 is substantially parallel to the conductive wire surface 231. The connector 24 is located between the printed circuit board 23 and the lamps 22 to electrically connect the connecting portion 221 and the printed circuit board 23. The printed circuit board 23 may lie parallel to the lamps 22 or the connecting portion 221. In this embodiment, the connector 24 may comprise copper, tin or a combination thereof. The lamps 22 may be cold cathode fluorescent lamps (CCFLs) or external electrode fluorescent lamps (EEFLs).

The conductive wire surface 231 has a regional feedback circuit to connect and control the lamps 22 regionally (shown as region A, region B and region C). The invention provides a plurality of lamps 22 which can be divided into several groups to be separately controlled by the printed circuit board 23. Besides, all the lamps may be controlled by a single feedback circuit on the printed circuit board. In the invention, lamp regions (shown as region A, region B and region C) can be controlled individually by the printed circuit board and can average the brightness of the light module to increase the luminous efficiency.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A light module comprising:
a printed circuit board having a conductive wire surface;
a lamp having a connecting portion electrically connected to the conductive wire surface in a manner that the lamp is substantially parallel to the conductive wire surface; and
a connector, disposed between the printed circuit board and the lamp, for electrically connecting the connecting portion and the printed circuit board.

2. The light module of claim 1, wherein the connector comprises copper, tin, or a combination thereof.

3. The light module of claim 1, wherein the lamp comprises an electrode electrically connected to the connecting portion.

4. The light module of claim 3, further comprising an electrode cover adapted to accommodate the electrode.

5. The light module of claim 1, wherein the lamp is a cold cathode fluorescent lamp (CCFL).

6. The light module of claim 1, wherein the lamp is an external electrode fluorescent lamp (EEFL).
